(19) United States
(12) Patent Application Publication
(10) Pub. No.: US 2004/0073824 A1
(43) Pub. Date: Apr. 15, 2004

(54) Information processing device with sleep mode function

(75) Inventor: Hironobu Machida, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/266,697

(22) Filed: Oct. 9, 2002

(51) Int. Cl. G06F 1/32

(52) U.S. Cl. 713/323

(57) ABSTRACT

The present invention as disclosed hereby is to provide an information processing device with sleep mode function which is capable of running in a sleep mode, thereby reducing the power consumption for its accompanying device and main memory. In the information processing device with sleep mode function, its system CPU 10 during a normal operation mode loads a required control program from a ROM 12 to the main memory 11 and executes it to monitor an operating state of the accompanying device 2-9, and then executes a sleep controlling program stored in a sleep ROM 13 when it is detected that any operation request for the accompanying device has not been performed within a predetermined period of time. Upon execution of this sleep controlling program, the accompanying device is powered down with the exception of its reactivation-request generating function part and the clock supply to the main memory, the power supply to the main memory or both of them is(are) turned off, thereby allowing the information processing device to place in a waiting state for an interrupt from the accompanying device. Accordingly, the primary power for the accompanying device and the main memory is not wasted, thereby providing reduction of the power consumption.

### BACKGROUND OF THE INVENTION

1. Field of the Invention

The present invention relates to an information processing device that is equipped with sleep mode function which serves for energy-saving, and particularly relates to an information processing device with sleep mode function, like an image forming device, comprising: an image information inputting section adapted to capture therein image information; an image information outputting section adapted to perform a desired processing of the captured image information and outputs it; a controlling panel section adapted to receive an command externally, based on the external command, provide instructions on various processing steps from an image information capture performed by the image information inputting section to an image information output performed by the image information outputting section and display the state of any processing step to be performed if needs arise; and a control section adapted to perform processing of an access from at least one of accompanying devices inclusive of the above-mentioned sections.

2. Description of the Related Art

In an image forming device as a conventional information processing device with sleep mode function, a control program is stored in a non-volatile ROM regardless of its low speed because its content stored therein will not be lost even when a power supply is turned off. Its control section, at the time of execution of the control program, transfers a copy of the control program stored in the ROM to a DRAM as a low cost, high-speed and large capacity volatile memory, and then execute it. Thus, a high-speed execution of the control program has been implemented. However, since the DRAM is the volatile memory, the control program content copied into the DRAM will be dissipated when the power supply is turned off. Accordingly, every time the power supply is turned on, the control program must be loaded from the ROM to the DRAM. In a recent device type, a program capacity is gradually increased to meet its multi-functional performance and therefore its control program tends to be stored in a ROM in a compression form. Upon execution of the program, the compressed control program is loaded from the ROM to the DRAM and then expanded for execution thereof.

The conventional image forming device as mentioned above is advanced in multifunction, like a digital copying machine for example, and remarkably increased in power consumption because of a capacity increase of its main memory in order to deal with various built-in accompanying devices (or attachments) and an elongated control program for implementing the multifunction. To reduce the power consumption, a so-called sleep mode is executed to turn off the power supply to the accompanying devices when the image forming device is not operated over a long period of time. Further, regarding the main memory, a low power consumption mode (a self-refresh mode) is executed so as to reduce the power consumption while remaining stored contents in the memory. However, even in the low power consumption mode, a considerable electric power is still required and a clock supply to the main memory is also required, thereby leading to an insufficient reduction of the power consumption.

### SUMMARY OF THE INVENTION

In order to address such a problem and the other problems, the present invention is accomplished and its object is to provide an information processing device with sleep mode function by which significant power savings can be achieved in a main memory upon execution of a sleep mode.

According to an aspect of the present invention, there is provided an image processing device comprising: a first non-volatile memory storing therein a control program; a second non-volatile memory storing therein a sleep controlling program; a volatile main memory; control program loading and executing means for loading a control program from the first non-volatile memory to the main memory and then executing it to dealing with any request issued from an accompanying device; operating state monitoring means for monitoring an operating state of the accompanying device according to the control program executed by the control program loading and executing means;

and sleep mode controlling means capable of entering an execution state of the sleep controlling program stored in the second non-volatile memory when it is decided by the operating state monitoring means that any operation request for the accompanying device has not been performed within a predetermined period of time and being placed in a waiting state for a reactivation-interrupt for reactivating the accompanying device. In this case, the sleep mode controlling means, when being in the execution state of the sleep controlling program, can make into an off-state a power source for the accompanying device with the exception of its reactivation-interrupt generating function part and simultaneously stop at least one of a clock supply and a power supply to the main memory.

Also, the operating state monitoring means according to the present invention, at the time when it is in a normal operation mode, monitors the operating state of the accompanying device repeatedly every a constant period and counts the frequency of continuous decisions each made such that any operation request for the accompanying device has not been performed, and can finally decide that the operation request for the accompanying device has not been performed within the predetermined period of time if the count reaches a predetermined value as a sleep setting value. In this case, the sleep setting value can be externally changed by a user. It will be appreciated by those of ordinary skill in the art that the information processing device with sleep mode function according to the present invention can be applied to an image forming device, a multi-function peripherals and the like.

According to another aspect of the present invention, there is provided an image processing device comprising: a first non-volatile memory storing therein a control program; a second non-volatile memory storing therein a sleep controlling program; a volatile main memory; and a system CPU adapted to load the control program from said first non-volatile memory to said main memory and execute it for processing any request from an accompanying device, said system CPU further adapted to, when monitoring an operating state of the accompanying device according the control program, enter an execution state of the sleep controlling program stored in said second non-volatile memory when it is detected that any operation request for the accompanying device has not been performed within a predetermined period of time, to make into an off-state a power source for the accompanying device with the exception of its reactivation-interrupt generating function part while simultaneously stopping at least one of a clock supply and a power supply to the main memory, and then to be placed in a waiting state for an interrupt until a reactivation-interrupt for reactivating the accompanying device is generated.

Further, the accompanying device comprises: a scanner subsystem adapted to capture image information; a printer subsystem adapted to perform an instructed processing of the captured image information and print it; a page memory subsystem adapted to receive/giving (transfer) an image data in a page unit; and a controlling panel section adapted to notify the system CPU on receipt of an external instruction and display information in response to an instruction issued from the system CPU. These various subsystems and sections are, with the exception of their reactivation-interrupt generating function parts, each able to make into an off-state its power source in response to an instruction issued from the system CPU.

With the configuration as mentioned above, the system CPU during the normal operation mode loads a required control program from the first non-volatile memory to the main memory and executes it to monitor the operating state of the accompanying device, and then executes the sleep controlling program stored in the second non-volatile memory when it is detected that any operation request for the accompanying device has not been performed within a predetermined period of time. Upon execution of this sleep controlling program, the accompanying device is powered down with the exception of its reactivation-request generating function part and the clock supply to the main memory, the power supply to the main memory or both of them is(are) turned off, thereby allowing the image forming device to place in a waiting state for an interrupt from the accompanying device. Accordingly, minimal power is required for the second non-volatile memory but primary power for the accompanying device and the main memory is not wasted, thereby providing reduction of the power consumption.

### BRIEF DESCRIPTION OF THE DRAWINGS

FIG. 1 is a schematic block diagram showing an image forming device of an embodiment according to the present invention;

FIG. 2 is a schematic block diagram showing an internal configuration of a system CPU of FIG. 1;

FIG. 3 is a schematic block diagram showing an internal configuration of a page memory controlling section in a page memory subsystem as shown in FIG. 1;

FIG. 4 is a schematic block diagram showing an internal configuration of a PM-CON as shown in FIG. 3;

FIG. 5(a) is a schematic diagram showing an entire memory map of the system CPU of FIG. 1;

FIG. 5(b) illustrates storage contents disposed in a ROM for booting and arranged at from an address No. I to the front of an address No. J;

FIG. 6 is a flow chart showing processing steps of a booting program stored as shown in FIG. 5(b);

FIG. 7 is a software configuration of the image forming device of the embodiment;

FIG. 8 is a configuration of processing blocks of a sleep controlling program stored in a sleep ROM as shown in FIG. 1;

FIG. 9 is a flow chart showing processing steps according to a sleep monitoring timer;

FIG. 10 is a flow chart showing processing steps according to a sleep transiting task;

FIG. 11 is a flow chart showing a first processing step according to the sleep controlling program;

FIG. 12 is a flow chart showing a second processing step according to the sleep controlling program; and

FIG. 13 is a flow chart showing a third processing step according to the sleep controlling program.

### PREFERRED EMBODIMENT OF THE PRESENT INVENTION

Hereinafter, an information forming device with sleep mode function of a preferred embodiment according to the present invention will be described with reference to the accompanying drawings. This image forming device will be described to exemplify an information processing device with sleep mode function.

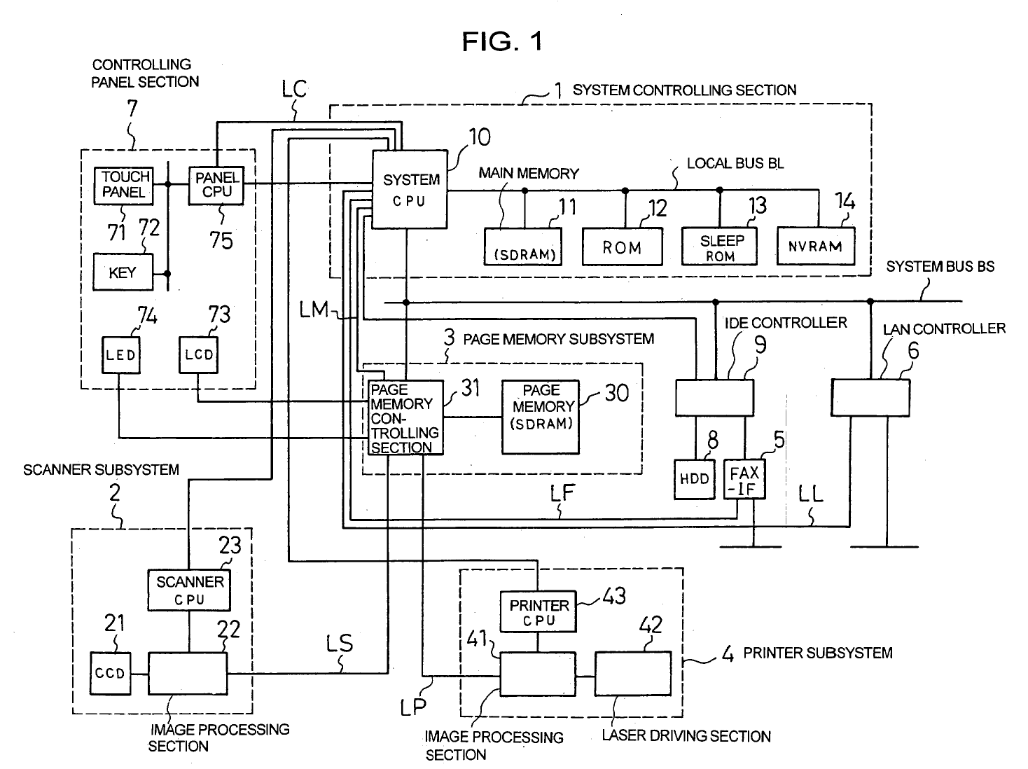

The image forming device as shown in FIG. 1 comprises: a system controlling section 1; a scanner subsystem 2; a page memory subsystem 3; a printer subsystem 4; a FAX-IF 5; a LAN controller 6; a controlling panel section 7; an HDD 8 as a large capacity hard disk; and an IDE controller 9. In this example, the system controlling section 1 is adapted to control the image forming device overall. The scanner subsystem 2 is adapted to read a document and converts it into a digital signal. The page memory subsystem 3 is adapted to temporarily store therein image data in digital signal form and in a page unit. The printer subsystem 4 is adapted to print on paper the image data in digital signal as an image and output it.

The FAX-IF 5 as an facsimile-interface is adapted to serve as an interface for sending/receiving of image data between the other facsimile apparatus provided externally and this image forming device. The LAN controller 6 is adapted to control a sending/receiving of data to/from another data processing device (e.g., other PC) connected via a LAN to this image forming device. The controlling panel section 7 is adapted to display an operating state of the image forming device such as a paper jam or the like or to accommodate an external access in connection with settings of various parameters and operations modes conducted at the time of copying by a user. The HDD 8 has a large capacity and is adapted to accumulate a plurality of image data therein. The IDE controller 9 is adapted to serves as an interface between a system bus BS and the FAX-IF 5 or the HDD 8. In addition, the scanner subsystem 2, the printer subsystem 4 and the controlling panel section 7 have respective CPU's which are permitted to send/receive control information via a serial IF to/from a system CPU 10 of the system controlling section 1.

The system controlling section 1 comprises: the system CPU 10 adapted to control the device overall; a ROM 12 connected to a local bus BL of the system CPU 10 and adapted to store therein a control program for controlling the device overall in a normal operation mode; a main memory 11 (composed of volatile DRAM in this example) into which, upon power-up, the system CPU 10 loads the control program read from the ROM 12 for executing it; a sleep ROM 13 adapted to store therein a sleep controlling program for executing a transition from the normal operation mode to a sleep mode, a control during the sleep mode and a control of the return from the sleep mode to the normal operation mode; and an NVRAM 14 adapted to store therein respective settings of various sections 2-9 as mentioned above and backed-up by a battery.

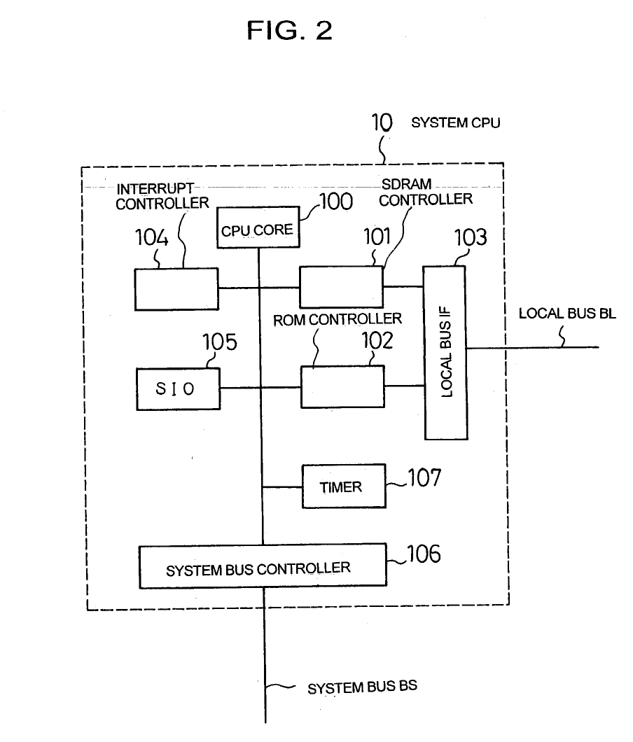

As shown in FIG. 2, the system CPU 10 comprises: a CPU core 100 adapted to execute the control programs for the normal operation mode and the sleep mode; a SDRAM controller 101 adapted to control the main memory 11 (SDRAM) connected via the local bus BL; a ROM controller 102 adapted to control the ROM 12 and the NVRAM 14 connected via the local bus BL; a local bus IF 103 adapted to serves as an interface of each of the SDRAM controller 101 and the ROM controller 102 with respect to the local bus BL; an interrupt controller 104 adapted to input interrupts from various sections on the device and sequentially notify the CPU core 100 of interrupts selected based on a predetermined priority; a three-channel serial input/output device (SIO) 105 adapted to serves as an interface for communication of each of a scanner CPU 23, a printer CPU 43 and a controlling panel CPU 75 with respective to the system CPU core 100; a system bus controller 106 adapted to interface respective sections connected to the system bus BS; and a timer 107.

The scanner subsystem 2 comprises: a document conveying section (not shown) adapted to convey a document at a predetermined timing; a CCD 21 adapted to optically read the document in a line unit in synchronization with the document conveying section and convert the document optically read into an electrical signal; an image processing section 22 adapted to convert the electrical signal outputted from the CCD 21 into data of 8 bits/pixel for example, subject the data to an image processing appropriate for a designated image mode such as a character mode, a character-photograph mode or a photograph mode, thereafter subject it to the gradation processing to form data of 1 bit/pixel and output the resultant image data to a page memory controlling section 31 via a line LS at a predetermined timing; and the scanner CPU 23 adapted to control the scanner subsystem 2 overall.

The printer subsystem 4 comprises: an image processing section 41 adapted to read the image data temporarily stored in the page memory 30 via a line LP at a predetermined timing and subject the image data to the image processing in a designated mode; a laser driving section 42 adapted to convert the image data from the image processing section 41 into optical signals; an image forming section (not shown) adapted to form an image from the optical signals of the laser driving section 42 by using electrophotography and transfer it to a predetermined paper for output; and a printer CPU 43 adapted to control the printer subsystem 4 overall.

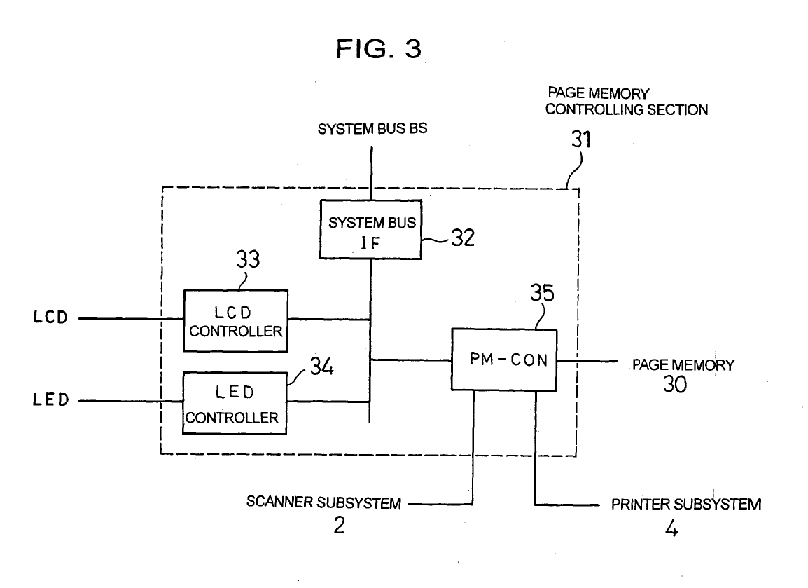

The page memory subsystem 3 comprises: a page memory 30 adapted to temporarily store therein image data in a page unit; and a page memory controlling section 31 adapted to control the page memory 30. As shown in FIG. 3, the page memory controlling section 31 comprises: a system bus interface (IF) 32 adapted to serves as an interface between the system bus BS and each of internal blocks of the page memory controlling section 31; an LCD controller 33; an LED controller 34; and a PM-CON 35 adapted to control the page memory 30. The PM-CON 35 adapted to arbitrate access requests from devices which attempt to access the page memory 30 according to the priority and sequentially authorize one access to the page memory 30 based on the arbitrated access requests.

Such devices, which will access to the page memory 30, includes: the image processing section 22 adapted to write the image data into the page memory 30 via the line LS; the image processing section 41 adapted to read the image data from the page memory 30 via the line LP; the system CPU 10; the LCD controller 33; the LED controller 34; and the IDE controller 9 adapted to accumulate the image data from the page memory 30 to the HDD 8 and return the image data accumulated in the HDD 8 to the page memory 30. The page memory 30 provides therein, in addition to a region temporarily storing therein the image data, a display data region storing therein display data for a display on the LCD. In this regard, the LCD controller 33 periodically read the display data from the display data region and then output the display data to the LCD 73 for allowing the LCD 73 to sequentially display the display data thereon.

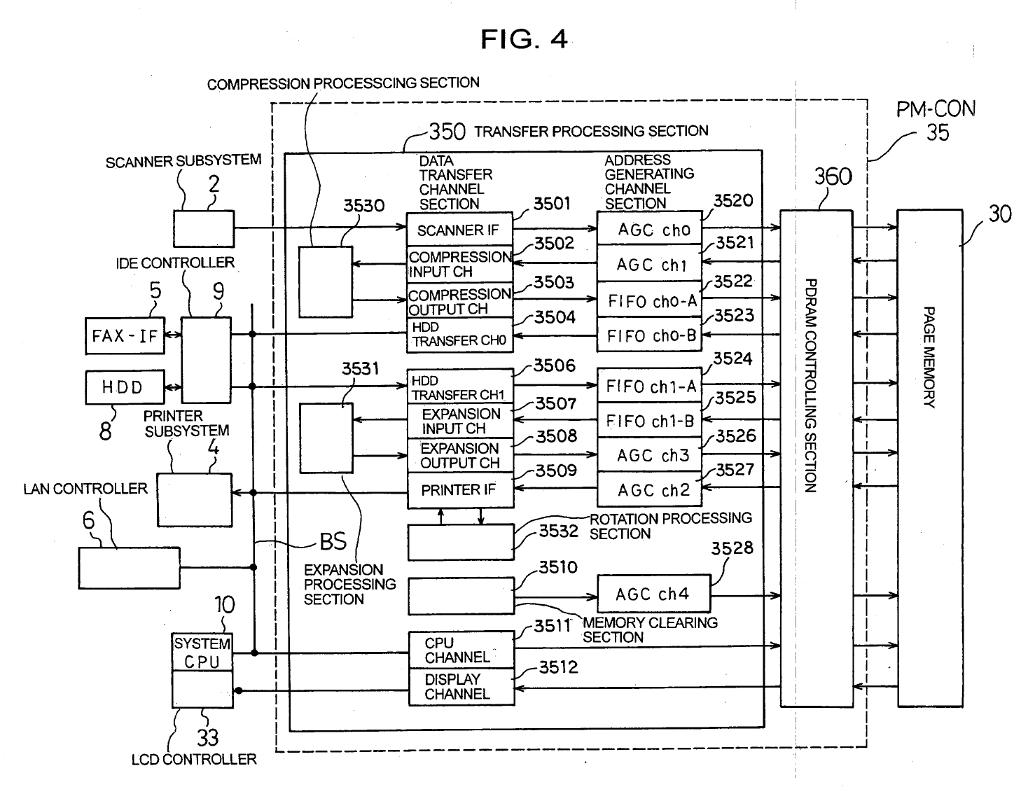

Next, the PM-CON 35 that actually controls the page memory 30 will be described in detail with reference to FIG. 4. The PM-CON 35 is comprised of a transfer processing section 350 and PDRAM controlling section 360. The transfer processing section 350 is adapted to serves as an interface regarding data transfer between the page memory 30 and each of the other processing blocks (e.g., the scanner subsystem 2, the FAX-IF 5, the HDD 8, the printer subsystem 4 and the like). The transfer processing section 350 includes a data transfer channel section and a address generating channel section.

The data transfer channel section comprises: a scanner interface (scanner IF, 3501); a compression input ch (3502); a compression output ch (3503); an HDD transfer ch0 (3504); an HDD transfer ch1 (3506); an expansion input ch (3507); an expansion output ch (3508); a printer interface (printer IF: 3509); a rotation processing section (3532); a memory clearing section (3510); a CPU channel (3511); a display channel (3512); a compression processing section (3530); and an expansion processing section (3531). The address generating channel section comprises: an AGC ch0 (3520); an AGC ch1 (3521), a FIFO ch0-A (3522); a FIFO ch0-B (3523); a FIFO ch1-A (3524); a FIFO ch1-B (3525); an AGC ch3 (3526); an AGC ch2 (3527); and an AGC ch4 (3528).

The scanner IF (3501) is adapted to capture image data in an 8-pixel unit for example outputted from the scanner subsystem 2 in synchronization with a synchronous signal outputted from the same scanner subsystem 2. At the time when the captured image data increases image data of 32 pixels which is a data transfer unit with respect to the page memory 30, a transfer request is outputted to the PDRAM controlling section 360. In synchronization with a data transfer enabling signal outputted from the PDRAM controlling section 360, the image data and address are passed to the PDRAM controlling section 360. This address is an address generated by the address generating channel AGC ch0 (3520) corresponding to the scanner transfer channel (3501).

The PDRAM controlling section 360 arbitrates transfer requests from respective transfer channels and decides a transfer enabling channel according to the priority such as Round Robin Scheduling. In the case of writing processing from a transfer channel to the page memory, the transfer enabling signal is outputted to a transfer channel which has been decided to be transfer-enabled, and image data and an address transmitted, in synchronization with and in response to the transfer enabling signal, from the transfer processing section 350 is received by the PDRAM controlling section 360. Then, the PDRAM controlling section 360 converts the received address into an address corresponding to the page memory 30 (SDRAM in this example) and generates a controlling signal for use in writing such that the received image data is written into a storage region in the page memory 30 at the corresponding address.

Each of the address generating channel sections (3520-3528) is able to generate a two-dimensional address corresponding to a document or paper and includes a main-scanning address counter and a sub-scanning address counter. The main-scanning address counter counts up each time that an access from the corresponding transfer channel is enabled by the PDRAM controlling section 360 and the access is ended or finished. When the main-scanning address counter counts up to a given setting of the document or paper, the sub-scanning address counter counts up while the main-scanning address counter is cleared.

When the processing steps are repeated and then both of the sub-scanning address counter and the main-scanning address counter count up to respective given settings determined for one page of the document or paper, it means that a transfer of that one page has been completed. At that time, the main-scanning address counter and sub-scanning address counter are cleared and simultaneously the fact that an access for that one page has been completed is notified to the system CPU 10 via a page memory ending interrupt line LM. The processing thus performed results in image data read by the scanner subsystem 2 being stored in the page memory 30.

The following description is provided to explaining a compression process of read image data. In response to an input request from the compression processing section (3530), the compression input channel (ch) (3502) outputs a request to the PDRAM controlling section 360 to capture image data written in the page memory 30 and send it to the compression processing section (3530). Since a setting of the address generating channel AGC ch1 (3521) employed here is similar to that of the address generating channel AGC ch0 (3520) used upon input of image data from the scanner subsystem 2, the image data previously transferred from the scanner subsystem 2 and stored in the page memory 30 is read from the page memory 30 and passed to the compression processing section (3530) for compression thereof. If compressed data that has been processed in the compression processing section (3530) is able to be outputted (there is existed compress data of a unit (e.g., 32 bits) writable into the page memory 30), the compression processing section (3530) requests the compression output channel (3503) to output the data. The compression output channel (3503) writes the compressed data into the page memory 30 in a manner similar to that of the scanner channel (3501).

The address generating channel section (FIFO ch1-A (3524), FIFO ch1-B (3525), FIFO ch0-A (3522), FIFO ch0-B (3523)) is a one-dimensional address generating channel which is comprised of a register for setting an initial address and a final address and a loop counter for counting up addresses from the initial address every access and loading the initial address to again count up addresses from the initial address if counting up to the final address. On the other hand, the FIFO ch1-A (3524) is paired with the FIFO ch1-B (3525) and the FIFO ch0-A (3522) is paired with the FIFO ch0-B (3523) such that they perform a FIFO counter operation of 2 channels (ch1 and ch0).

The FIFO counter operation can be explained as follows. In the event that, in connection with the ch0 (FIFO ch0-A (3522) and FIFO ch0-B (3523)), the FIFO ch0-A (3522) operates to write into the page memory 30 while the FIFO ch0-B (3523) operates to read from the page memory 30, an access for the reading (the FIFO ch0-B (3523)) is forced to wait when a count value of the FIFO ch0-B (3523) becomes equal to that of the FIFO ch0-A (3522) in order to prevent the reading from the page memory 30 from overtaking the writing into the page memory 30.

Also, the writing side (FIFO ch0-A) monitors a difference between both count values. When the difference is equal to “the final address—the initial address”, the writing side (FIFO ch0-A) performs data overwriting before the reading side (FIFO ch0-B) performs data reading so that the data is extinguished. In order to avoid this extinguish of the data, the operation of the writing side (FIFO ch0-A) is forced to wait. By virtue of the operations as mentioned above, the reading side (FIFO ch0-B) is able to accurately read only compressed data by the compression processing section (3530).

The HDD transfer ch0 (3504) and the HDD transfer ch1 (3506) are adapted to serves as an interface for data transfer between the HDD and the page memory 30. The HDD transfer ch0 (3504) outputs a transfer request, if being enabled to input data, and captures compressed data from the page memory 30. The IDE controller 9 obtains a control (right) for the system bus BS and draws data from the interior of the HDD transfer ch0 (3504) via the system bus BS to store the data in the HDD 8. Thus, the compression processing for one page is completed by repeating these operations as mentioned above.

The following description is provided to explain an expansion printing operation. The expansion printing operation basically follows the reverse course to the above-mentioned compression processing operation. First of all, if it is possible to output a compressed data, the HDD transfer ch1 (3506) captures the compressed data from the HDD 8 in response to a request from the IDE controller 9 and outputs a transfer request to the PDRAM controlling section 360 to, write the compressed data in the page memory 30. The expansion input ch (3507) outputs a request to the PDRAM controlling section 360, if it is possible to capture data into the channel. The expansion input ch (3507) reads the compressed data which has been captured into the page memory 30 from the HDD 8 by the HDD transfer ch1 (3506) and transfers it to the expansion processing section (3531). The expansion processing section (3531) performs the expansion processing of the compressed data thus transferred according to a predetermined algorism. If the resultant expanded data after that expansion processing is ready to be outputted, the expansion processing section (3531) outputs a request to the expansion output ch (3508). In response to the request, the expansion output ch (3508) receives the expanded data, and writes the received expanded data into the page memory 30 after issuance of a request to the PDRAM controlling section 360. These processing operations as mentioned above are repeated until the completion of the expansion processing for one page.

In the event that a rotation printing instruction is absent, the printer IF (3509) reads image data stored in a printing region of the page memory 30 by using the AGC ch2 (3527) and outputs the image data in synchronization with a synchronous signal outputted from the printer subsystem 4. In the event that the rotation printing instruction is present, the printer IF (3509) outputs the image data which has been subjected to the rotation processing in the rotation processing section (3532) in synchronization with the synchronous signal outputted from the printer subsystem 4.

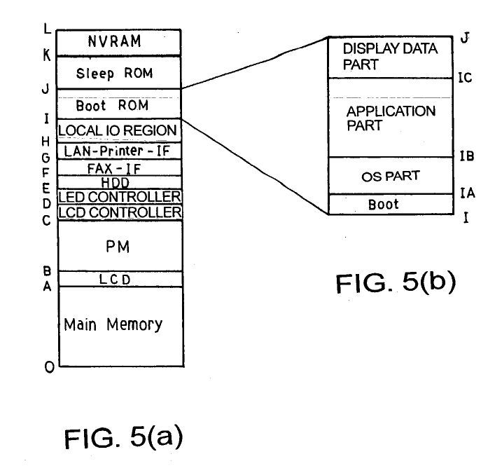

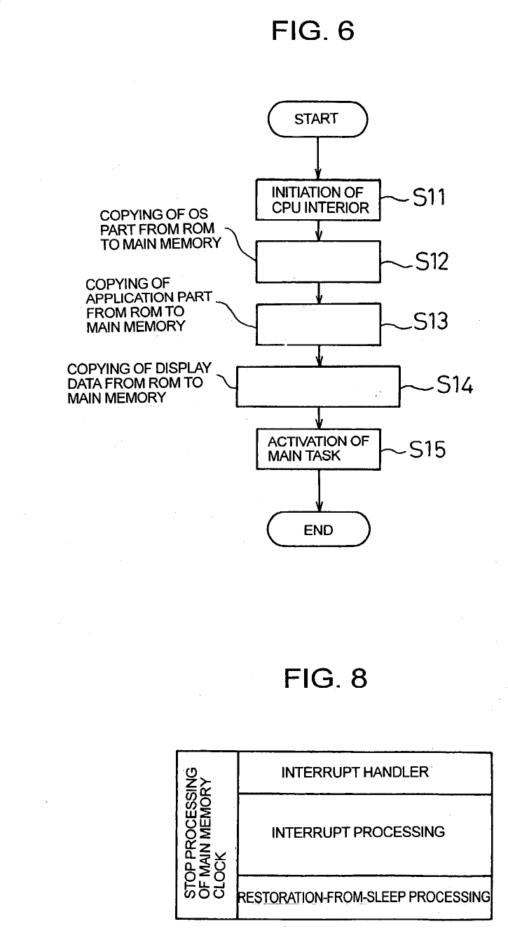

The following description is provided to explain a boot sequence with reference to FIGS. 5 and 6. FIG. 5(a) shows an entire memory map of the system CPU 10, and FIG. 5(b) shows storage contents of the ROM 12 which are arranged in from an address No. I and the front of an address No. J, for booting, as shown in FIG. 5(a) while FIG. 6 is a flow chart showing processing steps of a booting program stored therein. Upon power-up, the system CPU 10 commences an access to the address No. I at which the booting program is stored in the memory map to initialize various parts within the system CPU 10 as shown in FIG. 2(S11). After completion of the initialization, an OS part (FIG. 5(b)) is read from the ROM 12 and copied into a predetermined region in the main memory 11 (S12). Thereafter, an application part and a display data part are sequentially read from the ROM 12 and copied into respective predetermined regions in the main memory 11 (S13, S14). After completion of these copying operations, the system CPU 10 activates a main task from the application program which has been copied into the main memory 11 and completes a booting processing (S15).

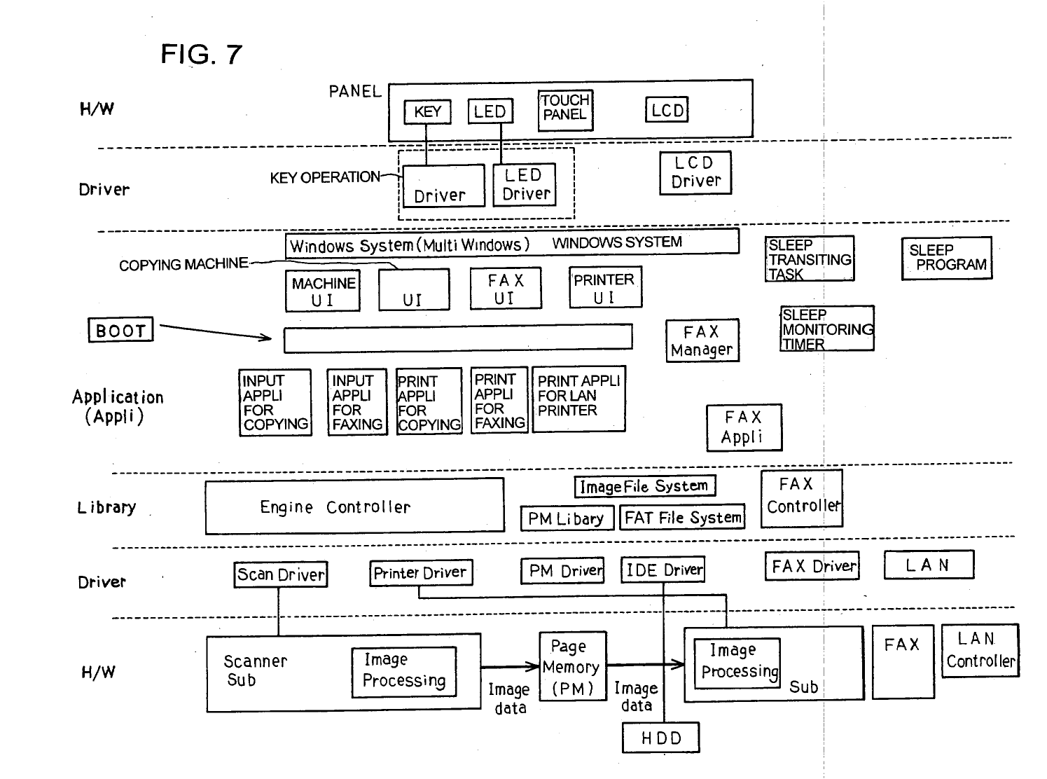

The following description is provided to explain a processing after completion of the booting processing with reference to FIG. 7 showing a software configuration of this image forming device. In FIG. 7, both of a library layer and a driver layer belong to the OS part as shown in FIG. 5(b). The main task which has been activated upon the booting processing activates an application task. The application task that will activate the main task includes: an input application (Appli) for copying adapted to control an input operation for copy processing; an input application for faxing adapted to control an input operation for fax processing; an printing application for copying adapted to control a printing operation for copy processing; a printing application for faxing adapted to control a printing operation for fax processing; a printing application for LAN printer adapted to control a printing operation in response to a printing request from a PC (inclusive of a personal computer and the other information processing devices) connected to a network; a fax application adapted to performs a control with respect to a facsimile line side; a fax manager (adapted to control an entire facsimile function by the input application for faxing, the printing application for faxing and the fax application); various user-interfaces (UI) adapted to serves as an interface between a user and each of parts of the image forming device via the controlling panel section 7; a sleep transiting task as detailed later on; and a sleep monitoring timer.

The user interface (UI) as mentioned above includes; a machine UI; a copying machine UI; a FAX UI; and a printer UI. The machine UI notifies a user of a machine state via the LCD, e.g., by displaying a jamming location on the LCD when a paper jam is occurred. The copying machine UI performs, via the LCD, various interfaces including settings of parameters regarding the copying processing. The FAX UI performs, via the LCD, various interfaces including settings of parameters regarding the facsimile processing. The printer UI performs, via the LCD, various interfaces including settings of parameters regarding the printer operation via the LAN. Also, the Windows System performs a display administration on the LCD by controlling various display information from respective UI's via a multi-window.

FIG. 8 shows a configuration of processing blocks of to the sleep controlling program which is stored in the sleep ROM 13. The sleep controlling program is comprised of; a main memory clock stoppage processing for stopping a clock supply to the main memory of a SDRAM; an interrupt handler for controlling an interrupt request as a trigger to restore the normal operation mode from the sleep mode; an interrupt processing for performing a processing in response to an interrupt request; and a restoration-from-sleep processing.

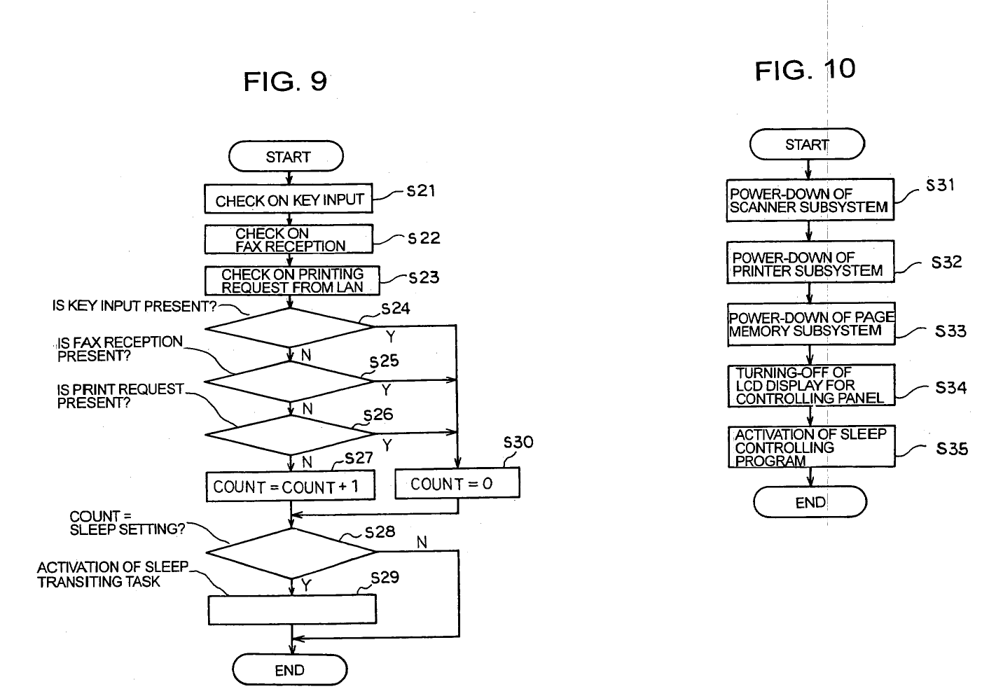

At a period which is set on the timer 107 (FIG. 2) of the system CPU 10, the system CPU 10 is periodically interrupted. The system CPU 10 calls the sleep monitoring timer (FIG. 7) every interrupt such that the sleep monitoring timer performs processing steps as shown in FIG. 9. Specifically, the sleep monitoring timer, first of all, performs a check on a key input of the controlling panel section 7 (S21), a check on a facsimile reception (S22), and a check on a state regarding a request from a PC connected to the LAN (S23), during such a calling period. After these checks, it is sequentially determined whether or not the key input of the controlling panel section 7 has been present (S24), whether or not the facsimile reception has been present (S25) and whether or not the printing request from the PC connected to the LAN has been present (S26).

When it is decided that any one of the events as mentioned above has been present, a count value of counter implemented in software in the sleep monitoring timer is cleared (S30). However, when it is decided that any one of the events has not been present, the count is counted up only by “1” (S27). Next, it is decided whether or not the count has reached a predetermined sleep setting value (S28). When it is decided that the count is equal to the sleep setting value (count=sleep setting), the sleep transiting task is activated (S29) and then this processing is ended. However, when it is decided that the count does not reach the sleep setting value, the processing at that cycle is ended without activation of the sleep transiting task.

The sleep setting value as mentioned above is selectable by a user from the controlling panel section 7, e.g., among “fifteen minutes”, “thirty minutes”, “forty five minutes”, “sixty minutes” and “non-sleep”, as a result of which the selected sleep setting value is stored in a predetermined region of the NVRAM 14. In general, before such a user's selective operation of the sleep setting value, the setting value, e.g., “thirty minutes” among the setting values as above is automatically stored in the NVRAM 14.

For example, in the event that the timer 107 is configured to generate an interrupt against the system CPU 10 every “1 second” in connection with an actual example of the sleep setting value, the sleep setting value of “thirty minutes” is calculated from the following equation (1).

Sleep setting value [30 minutes]={30×60[seconds]}/1[second]=1800 (1)

Here, it should be noted that the count of the counter for use in the sleep monitoring timer is initialized (=0) when the sleep monitoring timer is activated by the main task upon power-up.

The following description is provided to explain a processing operation of the sleep transiting task which is referred to in FIG. 7 and FIG. 9 with reference to FIG. 10. The sleep transiting task is activated by the sleep monitoring timer. After activation thereof, the sleep transiting task, for transiting to the sleep mode, makes instructions of a power-down of the scanner subsystem 2 (S31), power-down of the printer subsystem 4 (S32) and power-down of the page memory subsystem 3 (S33), and turns off the LCD display of the controlling panel section 7 (S34), thereafter activating the sleep controlling program employed during the sleep mode (S35). In this case, a reactivation-interrupt generating function part for generating a reactivation-interrupt keeps enabled.

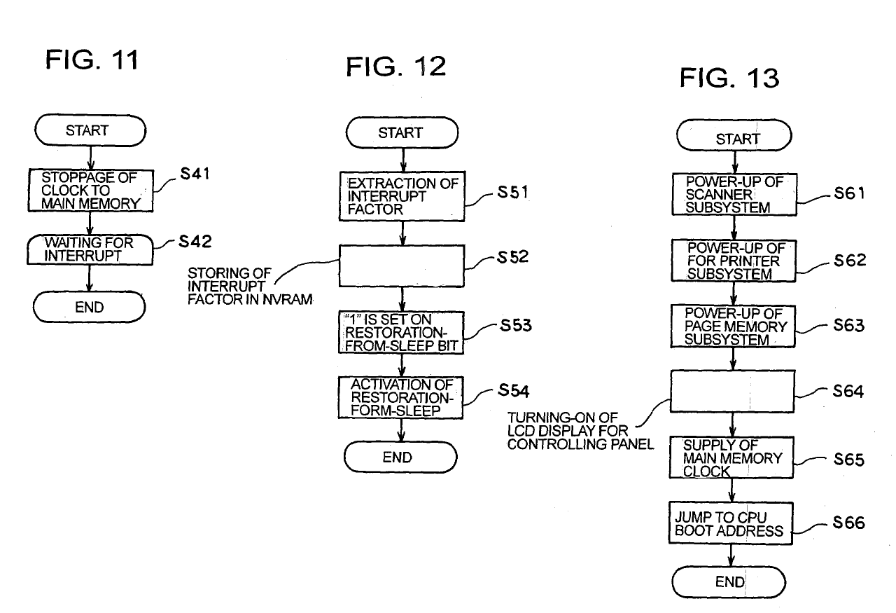

The following description is provided to explain a processing operation of the sleep controlling program with reference to flow charts of FIG. 11, FIG. 12 and FIG. 13. The sleep controlling program is activated by the sleep transiting task, thereby stopping the clock supply to the main memory 11 (S41) as shown in the flow chart of FIG. 11. With this stoppage of the clock supply, the main memory 11 is set in a non-operable state so that any programs loaded thereinto from the ROM 12 will be extinguished when being powered up. However, since the control by the system CPU 10 is already transited to the sleep controlling program stored in the sleep ROM 13, the system CPU 10 operates without any impediment even if any program stored in the main memory 11 is extinguished. After stoppage of clock, the sleep controlling program is placed in a waiting state for an interrupt as a trigger to restore the normal operation mode from the sleep mode (S42). At the step S41 as mentioned above, the clock supply is stopped but the power supply to the main memory may also be stopped or both of the clock supply and the power supply may be stopped.

In the event that there is generated an interrupt as a trigger to restore the normal operation mode from the sleep mode, an interrupt factor regarding that interrupt thus generated is extracted (S51) as shown in the flow chart of FIG. 12. Then, the extracted interrupt factor is stored in the NVRAM 14 (S52). In the event that there are generated a plurality of interrupts, interrupt factors involved with all interrupts thus generated are stored in the NVRAM 14. Next, the restoration-from-sleep bit indicative of a restoring operation from the sleep mode is turned on (=1), and stored in the NVRAM 14 (S53). Thereafter, the restoration-from-sleep processing is activated in order to perform the restoration-from-sleep processing (S54).

The following description is provided to explain the restoration-from-sleep processing with reference to a flow chart of FIG. 13. After the restoration-from-sleep processing is activated, the sleep controlling program performs the restoration processing of each of parts which were powered down by the sleep transiting task as shown in FIG. 10. In detail, the scanner subsystem 2 is powered up (S61), the printer subsystem 4 is powered up (S62), and the page memory subsystem 3 is powered up (S63). Further, the LCD display of the controlling panel section 7 is turned on (S64), the clock supply to the main memory 11 is commenced (S65), and a jump to a boot address for booting the system CPU 10 is performed in the ROM 12 (S66).

With the jump to the boot address as mentioned above, the system CPU 10 commences the booting processing as shown in FIG. 6 as a similar manner to that at the time when being powered up. The main task activated by the booting processing firstly makes a check on the restoration-from-sleep bit stored in the NVRAM 14. If the restoration-from-sleep bit is “1”, the interrupt factor which has already been stored in the NVRAM 14 by the sleep controlling program is read. If the interrupt factor thus read is an interrupt attributed to any key input or the like from the controlling panel section 7, its corresponding processing is commenced at the time when a “start key” is depressed after waiting for the completion of user's key input. In this case, the panel CPU 75 periodically makes a check on the touch panel 71 and the key 72. When either one of the touch panel 71 and the key 72 is depressed, a code corresponding to the depressed one is sent via a line LC from the serial IF to the system CPU 10.

The SIO of the system CPU 10 (designated by reference numeral 105 in FIG. 2) receives the code sent via the line LC from the panel CPU 75 and notifies the CPU core 100 via the interrupt controller 104 that the code has already been received. The CPU core 100 identifies or recognizes the key 72 depressed from the notified code. In the event that the interrupt factor is an interrupt attributed to any facsimile reception sent via the line LF, the system CPU 10 receives image data from the FAX-IF 5 and controls the printer subsystem 4 to print it after waiting for a response of “READY” from the printer subsystem 4. Also, in the event that the interrupt factor is an interrupt attributed to a printing request sent via a line LL from the LAN controller 6, the system CPU 10 receives image data sent from the LAN controller 6 and controls the printer subsystem 4 to print it after waiting for a response of “READY” from the printer subsystem 4.

In this image forming device as described above, if its accompanying device or attachment such as the scanner subsystem 2, the page memory subsystem 3, the printer subsystem 4, the FAX-IF 5, the LAN controller 6, the controlling panel section 7 and the like is not operated and any operation requests from the accompanying devices are not generated or occurred continuously over a predetermined period of time, the system CPU 10 performs the sleep controlling program stored in the sleep ROM 13 provided independently to power down those accompanying devices, with the exception of their reactivation-interrupt generating function parts, and to stop the clock supply or the power supply to the main memory 11 or both of the supplies to the main memory 11. With this configuration, it is possible to reduce a wasted power consumption. Also, if there is generated a new interrupt attributed to an operation request such as a key operation or the like, the system CPU 10 operates by a certain program stored in the sleep ROM 13 so that the normal operation mode can be restored from the sleep mode without any delay by powering up an accompanying device(s) thus required, activating the main memory 11 and jumping to the boot address.

Since the image forming device according to the preferred embodiment of the present invention is configured as described above, the system CPU during the normal operation mode loads a required control program from a first non-volatile memory to the main memory and executes it to monitor an operating state of an accompanying device, and then executes the sleep controlling program stored in a second non-volatile memory when it is detected that any operation request for the accompanying device has not been performed within a predetermined period of time. Upon execution of this sleep controlling program, the accompanying device is powered down with the exception of their reactivation-request generating function parts and the clock supply to the main memory, the power supply to the main memory or both of them is(are) turned off, thereby allowing the image forming device to place in a waiting state for an interrupt from the accompanying device. Accordingly, minimal power is required for the second non-volatile memory but primary power for the accompanying device and the main memory is not wasted, thereby providing reduction of the power consumption.

In the embodiments as described above, the image forming device exemplifies the information processing device with sleep mode function but, needless to say, the present invention is applicable to all of information processing devices and/or communication devices equipped with sleep mode function such as a multi-function printer (MFP), a PC system and the like.

What is claimed is:

1. An information processing device with sleep mode function comprising:
a first non-volatile memory storing therein a control program;
a second non-volatile memory storing therein a sleep controlling program;
a volatile main memory;
control program loading and executing means for loading a control program from said first non-volatile memory to said main memory and then executing it to dealing with any request issued from an accompanying device;
operating state monitoring means for monitoring an operating state of said accompanying device according to said control program executed by said control program loading and executing means; and
sleep mode controlling means capable of entering an execution state of the sleep controlling program stored in said second non-volatile memory when it is decided by said operating state monitoring means that any operation request for the accompanying device has not been performed within a predetermined period of time, and being placed in a waiting, state for a reactivation-interrupt for reactivating the accompanying device.

2. The information processing device as claimed in claim 1, wherein said sleep mode controlling means when being in the execution state of the sleep controlling program, is adapted to power down the accompanying device with the exception of its reactivation interrupt generating function parts and to stop at least one of a clock supply and power supply to said main memory.

3. The information processing device as claimed in claim 1, wherein said operating state monitoring means is adapted to monitor the operating state of the accompanying device repeatedly every a constant period, to count the frequency of continuous decisions each made such that any operation request for the accompanying device has not been performed, and to finally decide that the operation request for the accompanying device has not been performed within the predetermined period of time if the count reaches a predetermined value as a sleep setting value.

4. The information processing device as claimed in claim 3, wherein the sleep setting value is changeable externally by a user.

5. The information processing device as claimed in claim 1, wherein said information processing device comprises either one of an image forming device and a multi-function printer.

6. An information processing device with sleep function comprising:
a first non-volatile memory storing therein a control program;
a second non-volatile memory storing therein a sleep controlling program;
a volatile main memory; and
a system CPU adapted to load the control program from said first non-volatile memory to said main memory and execute it for processing any request from an accompanying device, said system CPU further adapted to, when monitoring an operating state of the accompanying device according the control program, enter an execution state of the sleep controlling program stored in said second non-volatile memory when it is detected that any operation request for the accompanying device has not been performed within a predetermined period of time, to make into an off-state a power source for the accompanying device with the exception of its reactivation-interrupt generating function part while simultaneously stopping at least one of a clock supply and a power supply to the main memory, and then to be placed in a waiting state for an interrupt until a reactivation-interrupt for reactivating the accompanying device is generated.

7. The information processing device as claimed in claim 6, wherein the accompanying device comprises: a scanner subsystem adapted to capture image information; a printer subsystem adapted to perform an instructed processing of the captured image information and print it; a page memory subsystem adapted to receive/giving image data in a page unit; and a controlling panel section adapted to notify the system CPU on receipt of an external instruction and display information based on an instruction from the system CPU, said various sections or portions as recited above, with the exception of their reactivation-interrupt generating function parts, being each able to make into an off-state its corresponding power source.
